(19) United States
(12) Patent Application Publication
(10) Pub. No.: US 2020/0198290 A1
(43) Pub. Date: Jun. 25, 2020

(54) FABRIC STRUCTURE USED FOR FABRICATION OF WEARABLE SOFT EXOSKELETON SUIT AND WEARABLE SOFT EXOSKELETON SUIT FABRICATED BY THE SAME

(71) Applicant: Dong-Chan LEE, Seoul (KR)

(72) Inventor: Dong-Chan LEE, Seoul (KR)

(21) Appl. No.: 16/687,857

(22) Filed: Nov. 19, 2019

(30) Foreign Application Priority Data
Dec. 24, 2018 (KR) 10-2018-0168481

(51) Int. Cl. B32B 5/26; A61H 1/00; A61H 3/00; B32B 5/02; B25J 9/00

(52) U.S. Cl. CPC B32B 5/26; A61H 1/001; A61H 3/00; B32B 5/02; B25J 9/0006; B32B 2437/00; A61H 2201/165; A61H 2003/007; B32B 2307/208; B32B 2262/103; B32B 2262/106; A61H 2201/1207

(57) ABSTRACT

A fiber structure used for a wearable soft exoskeleton suit includes: a first and a second current-magnetic metal fiber layers arranged to face each other and configured to apply attraction to each other by application of electric current; and a variable rigidity fiber layer interposed between the first and second current-magnetic metal fiber layers and configured to be pressurized by movements of the first and second current-magnetic metal fiber layers when the first and second current-magnetic metal fiber layers come close to one another by attraction force caused by the application of electrical current thereto, so as to increase a rigidity thereof.

### CROSS-REFERENCE TO RELATED APPLICATION

This application claims priority to and the benefit of Korean Patent Application No. 10-201 8-0168481 filed in the Korean Intellectual Property Office on Dec. 24, 2018, the entire contents of which are incorporated herein by reference.

### TECHNICAL FIELD

The present invention relates to a fabric structure used for fabrication of a wearable soft exoskeleton suit that is worn on a human body and provides a force to assist muscle strength.

### BACKGROUND ART

In general, an exoskeleton apparatus, also known as a wearable robot, is a device that can increase a muscle strength of a user through wearing. Such an exoskeleton apparatus may be divided into an exoskeleton apparatus for an upper body and an exoskeleton apparatus for a lower body.

Recently, the exoskeleton apparatus which has various purposes such as assisting movement by assisting the muscle strength in the movement of the disabled and the elderly, as well as in the industrial field, for rehabilitation treatment for muscle patients, for soldiers with heavy military, or for industrial sites carrying heavy loads Is being actively developed.

An existing exoskeleton device includes a plurality of metallic skeletons constituting the exoskeleton, joints connecting the metallic skeletons to each other, a sensing unit for detecting movement, and a driving unit such as a motor for driving the joints and the like. Therefore, the sensing unit detects a wearer's movement and the driving unit drives a joint corresponding to the sensed movement so that the metallic skeleton can be operated to assist muscle strength.

Such an exoskeleton apparatus is configured to be soft so as to be enable a smooth body movement of the wearer, and at the same time, it is necessary to be configured to perform a supporting function through increasing rigidity. Such a function can be achieved by changing the rigidity of the fiber structure, and a method of controlling rigidity by selectively supplying air pressure or hydraulic pressure into the fiber structure has been introduced. However, this method requires not only reservoirs and pumps for supplying hydraulic or pneumatic pressures but also a passage for air or oil flow into the fiber structure, so there are problems of complicated structure and increased weight and there is also a problem in that the manufacturing cost becomes larger.

### DETAILED DESCRIPTION OF THE INVENTION

### [Technical Problem]

The problem to be solved by the present invention is to provide a fiber structure used for fabrication of a wearable soft exoskeleton suit that is lightweight and can adjust a rigidity through a simple structure.

### [Technical Solution]

A fiber structure used for a wearable soft exoskeleton suit according to an embodiment of the present invention includes: a first and a second current-magnetic metal fiber layers arranged to face each other and configured to apply attraction to each other by application of electric current; and a variable rigidity fiber layer interposed between the first and second current-magnetic metal fiber layers and configured to be pressurized by movements of the first and second current-magnetic metal fiber layers when the first and second current-magnetic metal fiber layers come close to one another by attraction force caused by the application of electrical current thereto, so as to increase a rigidity thereof.

The variable rigidity fiber layer may be formed of graphene fibers.

The variable rigidity fiber structure may be formed of the plurality of stacked graphene fibers having a mesh shape consisting of unit cells in a shape of polygonal shape.

The plurality of graphene fibers may be interlaced with one another in a thickness direction.

The fiber structure may further include a first and a second electrical insulation layers which are respectively disposed outside the first and second current-magnetic metal fiber layers.

A wearable soft exoskeleton suit according to an embodiment of the present invention may be fabricated by the fabric structure according to an embodiment of the present invention.

### [Advantageous Effects]

According to the present invention, the rigidity of a variable rigidity fiber layer can be adjusted by using the first and second current-magnetic metallic fiber layers and the variable rigidity fiber layer disposed therebetween, thereby increasing the rigidity of the fiber structure without supplying air pressure or hydraulic pressure. A wearable soft exoskeleton suit made of such a fiber structure has a light weight and a simple structure and can adjust the rigidity and can be manufactured at low cost.

### BRIEF DESCRIPTION OF DRAWINGS

FIG. 1 shows an example of a wearable soft exoskeleton suit according to an embodiment of the present invention.

FIG. 2 shows a fabric structure according to an embodiment of the present invention for fabricating a wearable soft exoskeleton suit.

FIG. 3 shows an exemplary current-magnetic metallic fiber layer of a fabric structure according to an embodiment of the present invention.

FIG. 4 shows an exemplary variable rigidity fiber layer of a fabric structure according to an embodiment of the present invention.

FIG. 5 is a sectional view showing a state in which a fiber structure according to an embodiment of the present invention is compressed by the application of a current.

### DETAILED DESCRIPTION OF THE EMBODIMENTS

Embodiments of the present invention will be described in detail with reference to the accompanying drawings.

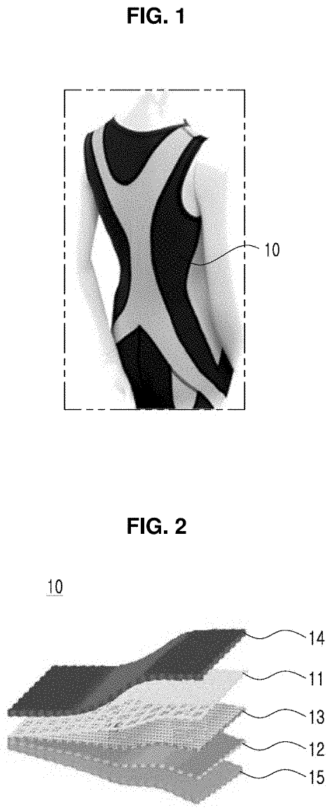

As shown in FIG. 1, the wearable soft exoskeleton suit according to an embodiment of the present invention is formed to have a shape that can be worn by a person. The wearable soft exoskeleton suit is formed such that the stiffness thereof is variable to be able to be adjusted and can perform the function of assisting the muscle power by adjusting the stiffness as necessary.

The wearable soft exoskeleton suit 10 may be made of a fiber structure that is formed such that the rigidity thereof can be adjusted when necessary. On the other hand, although not shown in the figure, the wearable soft exoskeleton suit 10 may include various components for the application and control of the current for stiffness adjustment.

As shown in FIG. 2, a first and a second current-magnetic metal fiber layers 11 and 12 are arranged to face each other. In FIG. 2, the first and second current-magnetic metal fiber layers 11 and 12 are shown to be bent for ease of understanding so as to be open at one side, but the first and second current-magnetic metal fiber layers 11 and 12 are substantially adjacent to one another to form a shape corresponding to the shape of each part of the human body. The first and second current-magnetic metal fiber layers 11 and 12 can be configured to exert attractive forces on each other by the application of a current. For example, the first and second current-magnetic metal fiber layers 11 and 12 are electrically connected in series to an external power source so that current can be applied to the first and second current-magnetic metal fiber layers 11 and 12 to flow therethrough. To this end, the first current-magnetic metal fiber layer 11 may be electrically connected to an anode (or cathode) of the external power source and the second current-magnetic metal fiber layer 12 may be electrically connected to the first current-magnetic metal fiber layer 11 and to a cathode (or anode) of the external power source. This constitutes a current circulation circuit and when a current is applied, current can flow through the first and second current-magnetic metal fiber layers 11 and 12.

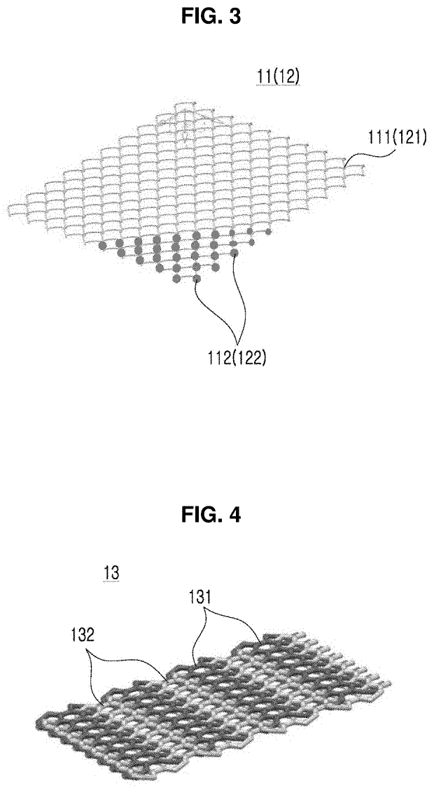

The first and second current-magnetic metal fiber layers 11 and 12 may be configured to become magnetic by the application of an electric current to attract to each other. For example, the first and second current-magnetic metal fiber layers 11 and 12 may be configured to have opposite magnetism when the current flows so that the attraction force is formed therebetween. This allows the first and second current-magnetic metal fiber layers 11 and 12 to move close toward each other by attraction caused by the application of a current. For example, as exemplarily shown in FIG. 3, the first and second current-magnetic metal fiber layers 11 and 12 may be formed by distributing current-magnetic metal particles 112 and 122 onto metal fibers 111 and 121 formed to have a net shape. The current-magnetic metal particles 112 and 122 may be magnetic particles containing magnetic metal such as nickel (Ni), cobalt (Co), iron (Fe), neodymium (Nd), samarium (Sm), iron (Fe) or the like.

A variable rigidity fiber layer 13 is interposed between the first and second current-magnetic metal fiber layers 11 and 12. The variable rigidity fiber layer 13 is configured to be pressurized to shrink when the first and second current-magnetic metal fiber layers 11 come close to one another by magnetic attraction force caused by the application of the current, so that the rigidity of the variable rigidity fiber layer 13 is increased.

The variable rigidity fiber layer 13 may be formed of graphene fibers. As exemplarily shown in FIG. 4, the variable rigidity fiber layer 13 may be formed of a plurality of stacked graphene fibers 131 and 132 of a mesh structure consisting of a unit cell of a polygonal shape (for example, hexagonal shape). Specifically, referring to FIG. 4, the plurality of graphene fibers 131 and 132 may be overlapped with each other in the thickness direction (vertical direction in FIG. 4) in a state of being interlaced with one another. That is, the graphene fibers 131 and 132 consisting of a plurality of unit shells are interlaced in the thickness direction again and are thus alternately disposed in a thickness direction. As a result, when the variable rigid fiber layer 13 is pressed by the approach of the first and second current-magnetic metal fiber layers 11 and 12, the graphene fibers 131 and 132 alternately interlaced in the thickness direction is being pressurized to shrink so as to secure an enhanced rigidity increase.

Meanwhile, according to an embodiment of the present invention, a first and a second electrical insulation layers 14 and 15 may be disposed outside the first and second current-magnetic metal fiber layers 11 and 12, respectively. The first and second electrical insulation layers 14 and 15 may be formed of soft material having electrical insulation property such as fibers and synthetic resins and may be adhered to the outer surfaces of the first and second current-magnetic metal fiber layers 11 and 12.

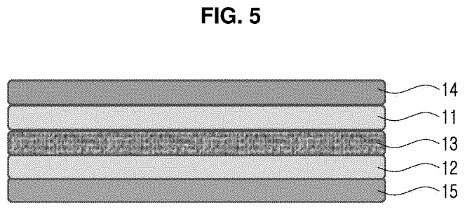

According to an embodiment of the present invention, when a current is applied to the first and second current-magnetic metal fiber layers 11 and 12, the first and second current-magnetic metal fiber layers 11 and 12 come close to one another by magnetic force as shown in FIG. 5, and thereby the variable rigidity fiber layer 13 is pressed to increase the rigidity. On the other hand, when the application of the current is released, the magnetic force acting on the first and second current-magnetic metal fiber layers 11 and 12 is released and the variable rigid fiber layer 13 expands by the elastic restoring force thereof, thereby reducing the rigidity to have a flexibility and an elasticity. According to an embodiment of the invention, since the rigidity of the variable rigidity fiber layer 13 can be adjusted by using the first and second current-magnetic metal fiber layers 11 and 12 and the variable rigidity fiber layer 13 disposed therebetween, the rigidity of the fiber structure can be increased without supplying air pressure or hydraulic pressure. A wearable soft exoskeleton suit made of such a fiber structure can have an adjustability of the rigidity while having a light weight and a simple structure and can be manufactured at low cost.

A wearable soft exoskeleton suit according to an embodiment of the present invention may be manufactured with a fiber structure according to an embodiment of the present invention described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A fiber structure used for a wearable soft exoskeleton suit comprising:
a first and a second current-magnetic metal fiber layers arranged to face each other and configured to apply attraction to each other by application of electric current; and
a variable rigidity fiber layer interposed between the first and second current-magnetic metal fiber layers and configured to be pressurized by movements of the first and second current-magnetic metal fiber layers when the first and second current-magnetic metal fiber layers come close to one another by attraction force caused by the application of electrical current thereto, so as to increase a rigidity thereof.

2. The fiber structure of claim 1, wherein the variable rigidity fiber layer is formed of graphene fibers.

3. The fiber structure of claim 2, wherein the variable rigidity fiber structure is formed of the plurality of stacked graphene fibers having a mesh shape consisting of unit cells in a shape of polygonal shape.

4. The fiber structure of claim 3, wherein the plurality of graphene fibers are interlaced with one another in a thickness direction.

5. The fiber structure of claim 1, further comprising a first and a second electrical insulation layers which are respectively disposed outside the first and second current-magnetic metal fiber layers.

6. A wearable soft exoskeleton suit fabricated by the fabric structure according to claim 1.
